(19) United States
(12) Patent Application Publication
(10) Pub. No.: US 2026/0312799 A1
(43) Pub. Date: Oct. 8, 2026

(54) METHOD, DEVICE AND COMPUTER PROGRAM FOR CARRYING OUT AN ELECTRONIC DRAW

(71) Applicant: LA FRANÇAISE DES JEUX, BOULOGNE-BILLANCOURT (FR)

(72) Inventor: Franck RICHARD, VELAUX (FR)

(21) Appl. No.: 18/998,485

(22) PCT Filed: Jul. 20, 2023
(86) PCT No.: PCT/FR2023/051131

§ 371 Date: Jan. 25, 2025

(30) Foreign Application Priority Data
Jul. 27, 2022 (FR) FR2207730

(51) Int. Cl. H04L 9/08; H04L 9/32

(52) U.S. Cl. CPC H04L 9/088; H04L 9/0866; H04L 9/3247

(57) ABSTRACT

The invention relates in particular to a method for carrying out an electronic draw in a device, the device comprising a first and second part, the first part being secure. After having obtained (505, 530), in the first part, at least one raw random number and at least one signature private key, said private key having been stored beforehand in the first part, said at least one obtained raw random number is signed, in the first part, using said at least one obtained private key, and transmitted (540) to a drawing module implemented in the second part.

The invention relates to the field of electronic draws, in particular to electronic draws for games of chance.

When a game requires a result related to chance, it is important that the device that makes it possible to obtain the result has no bias, that is to say that, statistically, the number of occurrences of a result is constant over a very large number of draws. By way of illustration, it is necessary, in a lotto draw system using balls associated with numbers, to use balls equivalent in terms of shape and weight. In the context of an electronic draw, specific devices offering very good qualities of chance are generally used. These devices implement draw functions that are based on the use of random numbers obtained from a module called a “random data generator”. This module is generally a hardware module that produces raw random data, generally binary, also called seed, which makes it possible, after scaling, to determine a result in a given interval defined by the desired draw, for example to obtain 5 digits between 1 and 49.

FIG. 1 illustrates an example of a gaming environment, wherein an electronic draw is implemented according to a known embodiment.

As illustrated, the gaming environment 100 here comprises a gaming device 105 such as a computer or a set of computers and a server 110 whereon an electronic drawing function is implemented. The gaming device 105 and the server 110 are connected to one another by a communication network 115, for example an Internet or Ethernet type network. The gaming device 105 makes it possible to execute gaming modules, for example a module making it possible for players to participate in a lottery game. When a draw must be carried out, a request 120 is transmitted to the server 110 that responds with a draw result 125. To provide a draw result, the server 110 comprises a data processing system 130. This data processing system comprises, for example, a microprocessor and an associated memory making it possible for the computer programs to be executed, referenced 135, as well as a cryptographic card 140. The cryptographic card 140 makes it possible to generate raw random numbers (seeds) securely. The cryptographic card 140 also makes it possible to store data securely, for example cryptographic keys, in particular private cryptographic keys that can be used to sign and thus authenticate the origin of data such as draw results.

As illustrated with reference to FIG. 2, a computer program executed by the microprocessor and the associated memory 135 can request raw random numbers from the cryptographic card 140, generate draw results from these raw random numbers, for example to provide sets of 5 digits between 1 and 49, and sign these draw results to make it possible to authenticate them.

FIG. 2 illustrates the logical architecture of a system for carrying out an electronic draw such as that described in FIG. 1. As illustrated, the cryptographic card 140 comprises a random number generator 200 that can, on request, send a raw random number to a scaling algorithm 205 implemented in the microprocessor and the associated memory 135. The scaling algorithm 205 then calculates a draw result from the received raw random number (seed), for example 5 digits between 1 and 49. This draw result is then sent to a signature module 210 that signs this result, as well as the raw random number used to calculate this result, for example using a private key obtained from a secure memory, referenced 215, of the cryptographic card 140. The signed draw result is then transmitted to the gaming device 105 that can use the draw result after authentication.

Although the solution described with reference to FIGS. 1 and 2 makes it possible to obtain quality results, it nevertheless has drawbacks.

First, it does not exclude an attack known as a “man in the middle” that can make it possible for an attacker connected to the server 110 to manipulate the generated raw random number (the seed) before draw results are calculated and signed (with the raw random number used). Having information about the seed, the attacker can then play combinations that are known to them before the draw.

This solution can also be the victim of a timing attack according to which a legitimate seed at a given time would be reused later. Thus, the attacker would steal a seed at a given time, study the results of a first draw, make a play for a second draw (knowing the results of the first draw), and reintroduce the seed used for the first draw into the system for the second draw.

Finally, this solution can also be the victim of an excessive replay attack, according to which an attacker plays a very large number of draws to find a complacent combination.

The aim of the present invention in particular is to solve these problems.

### DISCLOSURE OF THE INVENTION

For this purpose, the invention proposes a method, a device and a computer program for carrying out an electronic draw.

Thus, a method for carrying out an electronic draw in a device is proposed, the device comprising a first and second part, the first part being secure, the method comprising,
obtaining, in the first part, at least one raw random number,
obtaining, in the first part, at least one signature private key, said private key having been stored beforehand in the first part,
signing, in the first part, said at least one obtained raw random number using said at least one obtained private key, and
transmitting signed data to a drawing module implemented in the second part.

The method according to the invention thus makes it possible to improve the reliability of electronic draws by signing data used for the draw in a secure environment and to thus make subsequent authentication of certain draw parameters and the verification thereof possible.

According to particular embodiments, the method further comprises a step of authenticating, in said drawing module, the received signed data and, if the received data are authenticated, a step of carrying out a draw from said at least one raw random number included in the received signed data.

Still according to particular embodiments, the method further comprises obtaining, in the first part, additional validation data, said signing comprising signing said at least one obtained raw random number and said obtained additional validation data using said at least one obtained private key.

Still according to particular embodiments, said additional validation data comprise a sequence number, time information and/or a hardware reference of said first part.

Still according to particular embodiments, the method further comprises, in said drawing module, a step of validating said at least one received raw random number, said validation being based on said additional validation data.

A system for carrying out an electronic draw is also proposed comprising a first and second device, the first device being secure and comprising a data processing unit configured to,
obtain at least one raw random number,
obtain at least one signature private key,
sign said at least one obtained raw random number using said at least one obtained private key, and
transmit the signed data to a drawing module implemented in the second device.

The system according to the invention thus makes it possible to improve the reliability of electronic draws by signing data used for the draw in a secure environment and thus make the subsequent authentication of certain draw parameters and the verification thereof possible.

According to particular embodiments, said second device comprises a data processing unit configured to authenticate received signed data and, if the received data is authenticated, to carry out a draw from said at least one raw random number included in the received signed data.

Still according to particular embodiments, the data processing unit of said first secure device is further configured to obtain additional validation data, said signature comprising signing said at least one obtained raw random number and said obtained additional validation data using said at least one obtained private key.

According to particular embodiments, the data processing unit of said second device is further configured to validate said at least one received raw random number, said validation being based on said additional validation data.

A computer program, implementing all or part of the method described hereinabove is per se advantageous, from the moment it makes the security of electronic draws possible.

Thus, another aim of the present invention is a computer program including instructions for implementing the method described above, when this program is executed by a processor.

This program may use any programming language (for example, an object language or other), and be in the form of an interpretable source code, a partially compiled code or a fully compiled code.

Another aspect relates to a non-transitory storage medium of a computer executable program, comprising a dataset representing one or more programs, said one or more programs comprising instructions for, during the execution of said one or more programs by a computer comprising a processing unit optionally coupled to memory means and to an input/output interface module, executing all or part of the method described hereinabove.

### BRIEF DESCRIPTION OF THE DRAWINGS

Other features, details and advantages of the invention will become apparent upon reading the detailed description hereinafter. This description is purely illustrative and should be read with reference to the appended drawings wherein:

FIG. 1 illustrates an example of a gaming environment, wherein an electronic draw is implemented according to a known embodiment;

FIG. 2 illustrates the logical architecture of a system for carrying out an electronic draw such as that described in FIG. 1;

FIG. 3 illustrates an example of an architecture of a system for carrying out an electronic draw according to embodiments of the invention;

FIG. 4 illustrates an example of a logical architecture of a part of the system for carrying out an electronic draw shown in FIG. 3;

FIG. 5 illustrates an example of steps implemented in a secure device for generating and transmitting a raw random number securely;

FIG. 6 shows an example of steps for obtaining a raw random number and for carrying out an electronic draw securely; and

FIG. 7 illustrates an example of a device that may be used to implement, at least partially, embodiments of the invention.

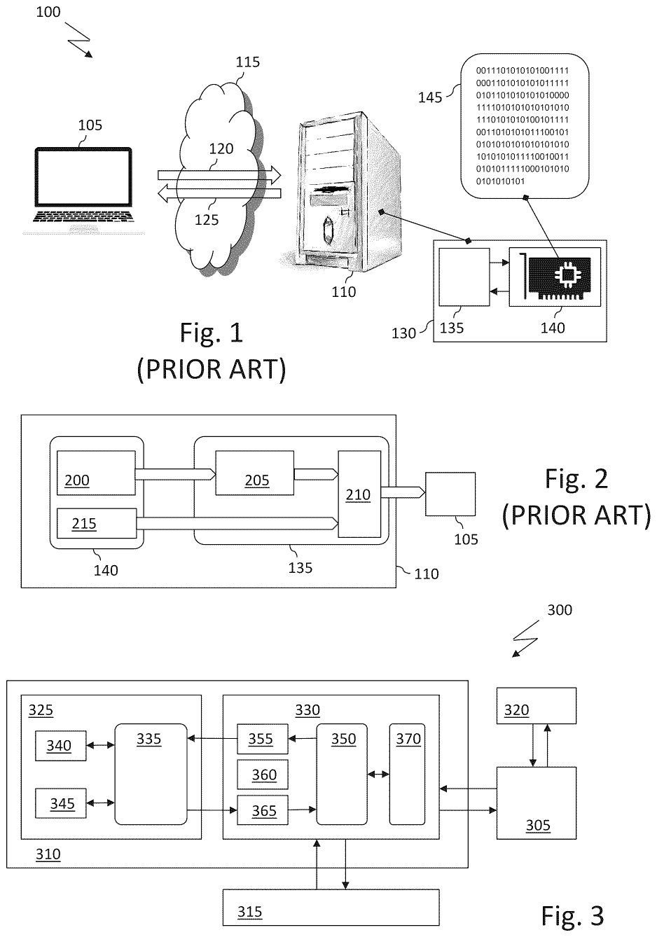

### DETAILED DESCRIPTION

According to particular embodiments, the aim of the invention is to execute an embedded program in a device having a high level of certification in terms of security, for example a device certified according to the common criteria EAL4+ (acronym for Evaluation Assurance level 4+), the embedded program, called a secure program, making it possible to carry out a digital signature of a dataset comprising, for example, a raw random number (seed) used for a draw and, preferably time information, a sequence number and/or a serial number (or any other unique or non-unique reference) of the hardware used. After signing, this dataset can be considered tamper-proof. The data contained in this set can then be authenticated and used throughout the drawing process, and the integrity thereof can be verified at any time. They can thus be used in particular in a drawing module that can for example be implemented in a server in which the secure hardware device used to generate and sign the raw random numbers and other parameters is connected.

By way of illustration, the secure device can be (or comprise) the device known as the HSM nShield Connect from Entrust Datacard, which is FIPS 140-2 and Common criteria EAL 4+ (EN 419.221-5) certified, meets the requirements of the European Union's elDAS (electronic Identification, Authentication and Trust Services) regulation and provides scalable and highly available encryption key services.

To carry out a draw, the drawing module sends a request to the secure program, executed inside the secure device (i.e. the secure program is embedded in the secure device), in order to obtain a raw random number. As described above, the secure program responds with a signed dataset preferably comprising:
a raw random number (the seed) necessary for the draw,
time information such as the date and time when the secure hardware device generated the raw random number, which makes it possible to subsequently check the age of the seed,
a sequence number such as a seed generation sequence number, which makes it possible to avoid excessive draw attacks (it being observed that a large number of draws could be carried out in a few seconds),
a serial number (or any other unique or non-unique reference) of the hardware used to carry out additional verifications, if any, and
a signature of all the previous data.

After the signature has been calculated in the secure device (for example, by encrypting a fingerprint of the data with a private key), the data can be authenticated according to a known process. For example, authentication can consist in comparing a fingerprint of the received data with that obtained from the signature received after it has been decrypted using the public key corresponding to the private key used (if the two fingerprints are different, this means that the data have been modified).

From an organizational point of view, the critical operations of this system (for example, the creation of signatures, the compilation of the secure program, the loading of this program into the secure device, etc.) are preferably carried out while respecting a separation of roles involving bailiffs. Thus, for example, the loading of secure programs and/or of data into the secure device can be carried out after authentication based on distributed secrets by using, for example, Shamir secret key sharing. By way of illustration, the secret used for authentication can be divided into a plurality of parts, for example 8, distributed into a plurality of roles, for example 2. In this case, authentication is carried out with at least 5 parts (authentication requires a quorum greater than one of the parts alone, which makes it mandatory to intervene both roles simultaneously).

FIG. 3 illustrates an example of an architecture of a system for carrying out an electronic draw according to embodiments of the invention.

As illustrated, the gaming environment 300 here comprises a gaming device 305 such as a computer or a set of computers, a server 310, a third-party device 315 making it possible to carry out checks and a device for timestamping gaming draws 320 (also called TSP, acronym for TimeStamping Platform). These devices are connected to one another by one or more communication networks, for example an Internet and/or Ethernet type network.

Like the gaming device 105, the gaming device 305 makes it possible to execute gaming modules, for example a module making it possible for players to participate in a lottery game. When a draw must be carried out, a request is sent to the server that responds with a draw result. The gaming device 305 is a system for carrying out an electronic draw where the draw games (for example the Keno and Euromillions games, Keno and Euromillions are registered trademarks) are configured. It can be a device accessible via a web-type interface, also known as EDS (acronym for Electronic Drawing Solution), which makes it possible to configure any game according to the features thereof.

As illustrated, the server 310 comprises a secure data processing device 325, for example the device known by the name HSM nShield Connect from entrust Datacard, and a data processing device 330 comprising for example a microprocessor and a memory, or front-end server, as described with reference to FIG. 7.

The secure data processing device 325 comprises in particular a data processing module 335 comprising a secure microprocessor and memory, a module 340 for generating raw random numbers and a secure memory 345. The secure memory 345, also called HSM (acronym for Hardware Storage Module) is a tamper-proof memory or electronic safe. It is impossible to output data from the outside. The secure memory 345 is used in particular to store a private key used to sign a dataset as described above. The data processing module 335 comprises the secure program used to obtain a raw random number (seed), time information, a sequence number and/or a serial number (or any other unique or non-unique reference) of the hardware used, as well as a private key and to sign the obtained data with the obtained private key. The raw random number is obtained (for example on request) from the module 340, the time information can be obtained from an internal clock of the secure device 325 and the sequence number, the serial number of the hardware used and the private key can be obtained from the secure memory 345 (the sequence number being, for example, incremented as soon as a raw random number is generated).

The data processing device 330 makes it possible to execute a drawing module per se comprising a plurality of modules, for example a drawing management module 350, a seed request module 355, a security module 360, a scaling module 365 and an interface 370, for example of the API (Application Programming Interface) type. The scaling module here implements an algorithm for scaling a seed into a combination of numbers drawn according to predetermined parameters. The interface 370 makes it possible in particular to receive draw requests from a gaming device and to transmit draw results.

The third-party device 315 can implement an independent control engine to perform security checks in order to verify that there are no fraud or errors in the drawing system. The input data of the control engine are, for example, execution data (or application logs) of the gaming device 305. The control engine verifies the signatures, verifies that the timestamping platform has been requested, that the drawn numbers are the correct ones, etc. This control engine is preferably executed at the end of the draw on an independent platform to verify all of the information of the draw, in order to validate that the draw is legitimate and integrated.

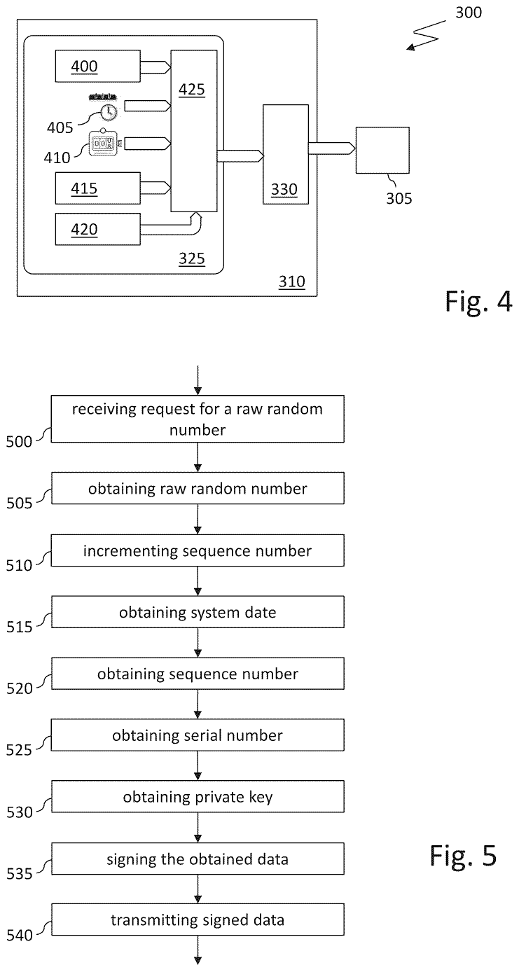

FIG. 4 illustrates an example of a logical architecture of a part of the system for carrying out an electronic draw shown in FIG. 3.

As illustrated, the secure program implemented in the secure device 325 is configured to obtain a raw random number (seed) 400, time information 405, a sequence number 410 and/or a serial number (or any other unique or non-unique reference) 415 of the hardware used as well as a private key 420 and to sign the obtained data (with the exception of the private key) with the obtained private key. The set of obtained data (seed, time information, sequence number and/or serial number) and the signature calculated on this dataset using the private key are then transmitted to the data processing device 330 to carry out the draw, preferably after authenticating and validating the received data.

FIG. 5 illustrates an example of steps implemented in a secure device, for example the secure device 325 of FIG. 3, for generating and transmitting a raw random number securely.

As illustrated, the object of a first step (step 500) is to receive a request to obtain a raw random number (seed). This request is for example received from the data processing device 330 illustrated in FIG. 3.

In a subsequent step, the raw random number is obtained (step 505). This raw random number is for example obtained in response to a request transmitted to the module 340 of FIG. 3. A sequence number is then preferably incremented (step 510), for example by the value one. The sequence number is, for example, stored in the secure memory 345. The initial value can be configured during system installation. In a subsequent step, at the same time or beforehand, time information is obtained (step 515). As described above, this information may correspond to the instant at which the raw random number is obtained. It can be obtained from a secure internal clock device 325 of FIG. 3. In subsequent steps, at the same time or beforehand, the sequence number, a serial number, for example that of the secure device 325, and a private key are obtained here (steps 520, 525 and 530, respectively), for example from the secure memory 325.

After having been obtained, the raw random number, the time information, the sequence number and/or the serial number are signed using the obtained private key (step 535), for example by using a known signature algorithm such as the signature algorithm known as RSA.

It is observed that according to other embodiments the signed dataset comprises the raw random number and, optionally, one or more data from the time information, the sequence number and the serial number. According to yet other embodiments, the dataset comprises other data.

The signed data, comprising the raw random number requested, are then transmitted (step 540), for example to a drawing module.

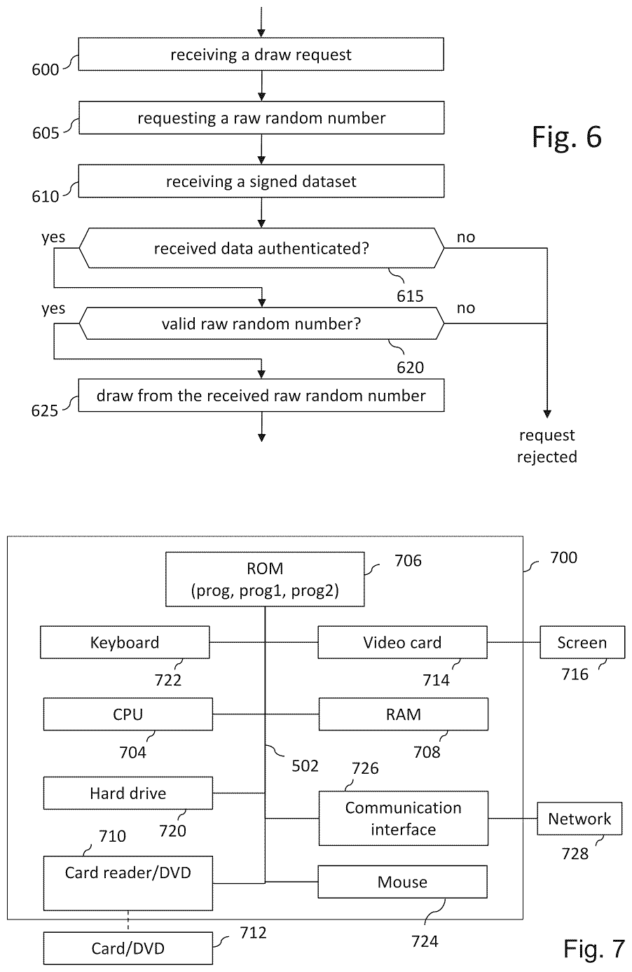

FIG. 6 illustrates an example of steps implemented in a drawing module executed, for example, in the data processing device 330 illustrated in FIG. 3, for obtaining a raw random number and for carrying out an electronic draw securely.

As illustrated, the object of a first step is to receive a draw request (step 600). This request is, for example, received from a gaming device such as the gaming device 305 in FIG. 3.

In a subsequent step, a request is sent to a secure device, for example the secure device 325 of FIG. 3, to obtain a raw random number or seed (step 605). In response to this request, a signed dataset is received (step 610), that is to say a dataset and a signature calculated on this dataset using a private key. This dataset comprises the raw random number requested as well as, for example, time information, a sequence number and/or a serial number (or any other unique or non-unique reference) of the hardware used to generate the raw random number.

In a subsequent step, a test for authenticating the received data is carried out (step 615). This test consists, for example, in calculating a fingerprint from the set of received data and in comparing this fingerprint with that obtained from the received signature decrypted with the public key corresponding to the private key used. If the signatures are different, the received data are not authenticated and the draw request is rejected. Otherwise, if the received data are authenticated, a test is preferably carried out to verify whether the received raw random number is valid (step 620). This test consists, for example, in comparing the time information with the current date. If the time information is later than the current date, it can be considered that the received raw random number is not valid. Furthermore, if the difference is greater than a given threshold, it can be considered that the received raw random number is too old. In these cases, the draw request may be rejected. Another test that can be carried out to verify whether the received raw random number is valid consists in verifying the received serial number or any other device reference with a corresponding data item received beforehand to verify that the received raw random number has indeed been generated by the secure device to which the request has been sent. Yet another test for verifying whether the received raw random number is valid consists in verifying that the received sequence number is consistent in particular with the number of draws carried out and with the number of draw requests received. Of course, there are many other types of tests that can be carried out. These tests can be implemented in a combined or targeted manner, for example according to the circumstances or randomly.

If the received raw random number is considered valid, a draw is carried out therefrom, according to predetermined parameters or parameters received from the gaming device requesting the draw. Otherwise, the draw request is preferably rejected.

FIG. 7 illustrates an example of a device that can be used to implement, at least partially, embodiments of the invention, in particular steps described with reference to FIGS. 3 to 6. It may concern, for example, the gaming device 305 of FIG. 3, the data processing device 330 of the server 310 of FIG. 3, the third-party device 315 of FIG. 3 or the timestamping device 320 of FIG. 3.

For example, the device 700 is a server blade, a server, a computer or a terminal.

Preferably, the device 700 includes a communication bus 702 to which are connected:
a central processing unit or microprocessor 704 (CPU, an acronym standing for Central Processing Unit);
a read-only memory 706 (ROM, an acronym standing for Read Only Memory) that may include an operating system and programs such as “Prog”;
a random-access memory or cache memory 708 (RAM, an acronym standing for Random Access Memory) including registers adapted to save variables and parameters created and modified during the execution of the aforementioned programs; and
a communication interface 726 connected to a distributed communication network 728, for example a wireless communication network and/or a local communication network, the interface being able to transmit and receive data, in particular to and from another device.

Optionally, the device 700 may also have the following elements:
a hard drive 720 that may include the aforementioned programs “Prog” and data processed or to be processed according to the invention;
a keyboard 722 and a mouse 724 or any other pointing device like a light pen, a touchscreen or a remote control making it possible for the user to interact with the programs according to the invention;
a reader 710 of a removable storage medium 712 such as a memory card or a disk, for example a DVD disk; and
a graphics card 714 connected to a screen 716.

The communication bus makes the communication and the interoperability between the different elements included in the device 700 or connected thereto possible. The representation of the bus is not restrictive and, in particular, the central unit may communicate instructions to any element of the device 700 directly or by means of another element of the device 700.

The executable code of each program making it possible for the programmable device to implement the processes according to the invention may be stored, for example, in the hard drive 720 or in the read-only memory 706.

According to an alternative embodiment, the executable code of the programs may be received by means of the communication network 728, via the interface 726, in order to be stored in a manner identical to the previously described one.

More generally, the program(s) may be loaded into one of the storage means of the device 700 before being executed.

The central unit 704 will control and direct the execution of the software code instructions or portions of the program(s) according to the invention, instructions that are stored in the hard drive 720 or in the read-only memory 706 or in the other aforementioned storage elements. Upon start-up, the program(s) that is/are stored in a non-volatile memory, for example the hard drive 720 or the read-only memory 706, is/are transferred into the random-access memory 708 that then contains the executable code of the program(s) according to the invention, as well as registers for storing the variables and parameters necessary for the implementation of the invention.

Depending on the embodiment chosen, certain acts, actions, events or functions of each of the methods described in the present document may be carried out or occur according to an order different to that wherein they have been described, or may be added, merged or even not be carried out or not occur, depending on the case. Furthermore, in certain embodiments, certain acts, actions or events are carried out or occur concurrently and not successively.

Although described through a certain number of examples of detailed embodiments, the method proposed and the equipment for implementing the method comprise various alternative embodiments, modifications and improvements that will become apparent to the person skilled in the art, it being understood that these various alternative embodiments, modifications and improvements fall within the scope of the invention, such as defined by the following claims. In addition, various aspects and features described hereinabove may be implemented together, or separately, or substitute one another, and all of the various combinations and sub-combinations of the aspects and features fall within the scope of the invention. Furthermore, it is possible that some systems and equipment described hereinabove do not incorporate all of the modules and functions described for the preferred embodiments.

1. Method for carrying out an electronic draw in a device, the device comprising a first and second part, the first part being secure, the method comprising,
obtaining in the first part, at least one raw random number,
obtaining in the first part, at least one signature private key, said at least one signature private key having been stored beforehand in the first part,
signing in the first part, said at least one raw random number obtained using said at least one signature private key obtained to obtain signed data, and
transmitting the signed data to a drawing module implemented in the second part.

2. The method according to claim 1, further comprising a authenticating, in said drawing module, the signed data received and, carrying out a draw from said at least one raw random number included in the signed data received in response to a determination that the signed data received is authenticated.

3. The method according to claim 1, further comprising obtaining additional validation data in the first part, said signing comprising signing said at least one raw random number obtained and said additional validation data obtained using said at least one signature private key obtained.

4. The method according to claim 3, wherein said additional validation data comprises at least one of a sequence number, time information and a hardware reference of said first part.

5. The method according to claim 3, further comprising validating said at least one raw random number, received by said drawing module based on said additional validation data.

6. A computer program recorded on a non-transitory media executable by a processor and comprising instructions for implementing each of the steps of the method according to claim 1.

7. A system to perform an electronic draw comprising a first and second device, the first device being secure and comprising a data processing unit configured to:
obtain at least one raw random number,
obtain at least one signature private key,
sign said at least one obtained raw random number obtained using said at least one signature private key obtained to obtain signed data, and
transmit the signed data to a drawing module implemented in the second device.

8. The system according to claim 7, wherein said second device comprises a data processing unit configured to authenticate signed data received and, to carry out a draw from said at least one raw random number included in the signed data received in response to a determination that the signed data received is authenticated.

9. The system according to claim 7, according to wherein the data processing unit of said first device is further configured to obtain additional validation data, and to sign said at least one raw random number obtained and said additional validation data using said at least one signature private key obtained.

10. The system according to claim 9, wherein said second device comprises a data processing configured to validate said at least one raw random number, received by said drawing module based on said additional validation data.
